(19) United States
(12) Patent Application Publication
(10) Pub. No.: US 2012/0113999 A1
(43) Pub. Date: May 10, 2012

(54) DRIVER FOR LASER DIODE IMPLEMENTED WITH OFFSET CONTROL

(75) Inventor: Keiji TANAKA, Yokohama (JP)

(73) Assignee: SUMITOMO ELECTRIC INDUSTRIES, LTD., Osaka (JP)

(21) Appl. No.: 13/290,235

(22) Filed: Nov. 7, 2011

(30) Foreign Application Priority Data
Nov. 9, 2010 (JP) JP 2010-250651

(51) Int. Cl. H01S 3/10

(52) U.S. Cl. 372/38.02

(57) ABSTRACT

A driver circuit for an LD is disclosed. The circuit includes a decision unit, an offset adjustor, and an amplifier each having the differential configuration in an embodiment. The decision unit decides and generates a signal LOS that distinguishes the existence/absence of the input signal. The offset adjustor, depending on the signal from the decision unit, adds/compensate the offset thereof. The amplifier, whose output are pulled up to the power supply Vcc through an inductor. Because the output of the offset adjustor compensates the offset thereof during the absence of the input signal, the output of the amplifier does not cause overshoot or undershoot.

### BACKGROUND OF THE INVENTION

1. Field of the Invention

The present invention relates to a circuit for driving semiconductor laser diode (hereafter denoted as LD).

2. Related Background Arts

An LD driver circuit is necessary to adjust a cross point of the driving signal in order to secure the quality of the optical signal because an LD generally shows a rising time of light emitted therefrom imbalanced to a falling time even the LD is driven by an electrical signal with a rising time balanced to a falling time. In another aspect, an optical fiber inherently shows dispersion and an optical signal propagated in such a fiber inevitably degrades the signal quality thereof; accordingly, an LD-driver is sometimes necessary to pre-deform the electrical output therefrom to compensate the dispersion of the optical fiber by shifting the cross point from the center 50%. Thus, a cross point adjustor is generally requested in an LD driver. United States patents, for instance, the U.S. Pat. No. 5,708,673 and the U.S. Pat. No. 6,795,656, have disclosed techniques to offset the electrical cross point from 50%.

In another aspect, the electronic circuit is continuously requested to reduce the power supply thereof. Assuming a condition where the LD driver is an subject to enhance the high frequency response under a condition of the power supply of 3.3V, which is very popular in currently designed electronic apparatus, a voltage margin prepared for respective active devices used in the circuit, which is widely called as the head room, becomes insufficient because of parasitic circuit elements such as inductance inherently attributed to a bonding wire of the device. Another United States patent, the U.S. Pat. No. 5,883,910, has disclosed a solution to widen the room by pulling the output of the LD driver to the power supply by an inductor.

However, a bipolar transistor having superior high frequency performance over 10 Gbps generally shows smaller breakdown voltage. In a case where such a bipolar transistor is put in the output stage of the LD driver which is pulled up to the power supply Vcc through the pull-up inductor, and when the input signal disappears by, for instance, entering a suspension mode of the burst signal, the output bipolar transistor sometimes breaks down. The present invention is to solve the subject above, specifically, the invention is to provide a technique to avoid the breakdown of the output transistor.

### SUMMARY OF THE INVENTION

The LD driver according to an embodiment of the present invention may include a decision unit, an offset adjustor, and an amplifier. The decision unit may generate a control signal whose level corresponds to the existence/absence of the input signal provided to the LD driver. The offset adjustor may receive the input signal and add an offset to the output thereof by receiving the control signal output from the decision unit. The amplifier may receive the output of the offset adjustor and drive the LD. The amplifier of the embodiment may have an output terminal connected to the LD and pulled up to the power supply Vcc through an inductor. A feature of the LD driver of the present invention is that the offset adjuster may add an offset to the output thereof when the input signal exists; while compensates the offset thereof when the input signal is absent.

The LD driver thus configured, because the output of the offset adjustor is compensated during the absent of the input signal, no overshoot or undershoot may be appeared at the instant when the input signal recovers and the control signal output from the decision unit and provided to the offset adjustor operates such that the substantial offset causes in the output of the offset adjustor.

### BRIEF DESCRIPTION OF THE DRAWINGS

Non-limiting and non-exhaustive embodiments of the present invention will be described with reference to the following figures, wherein like reference numerals refer to like parts throughout the various figures unless otherwise specified.

FIG. 1 is a functional block diagram of the LD driver according to an embodiment of the invention;

FIG. 2 is a circuit diagram of an example of the offset adjustor implemented within the LD driver shown in FIG. 1;

FIG. 3 shows time charts of signals observed in the LD driver shown in FIG. 1; and

FIG. 4 shows time charts of signals observed in a comparable LD driver that implements without any offset adjustor.

### DETAILED DESCRIPTION OF PREFERRED EMBODIMENTS

Next, some preferred embodiments according to the present invention will be described as referring to accompanying drawings. In the description of the drawings, the numerals or symbols same with or similar to each other will refer to elements same with each other without overlapping explanations.

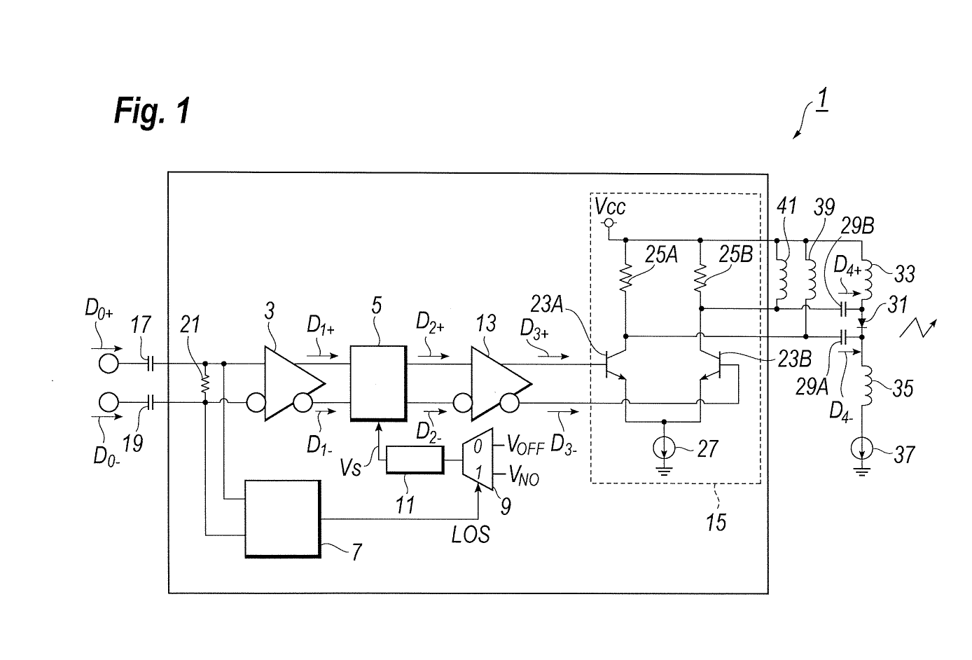

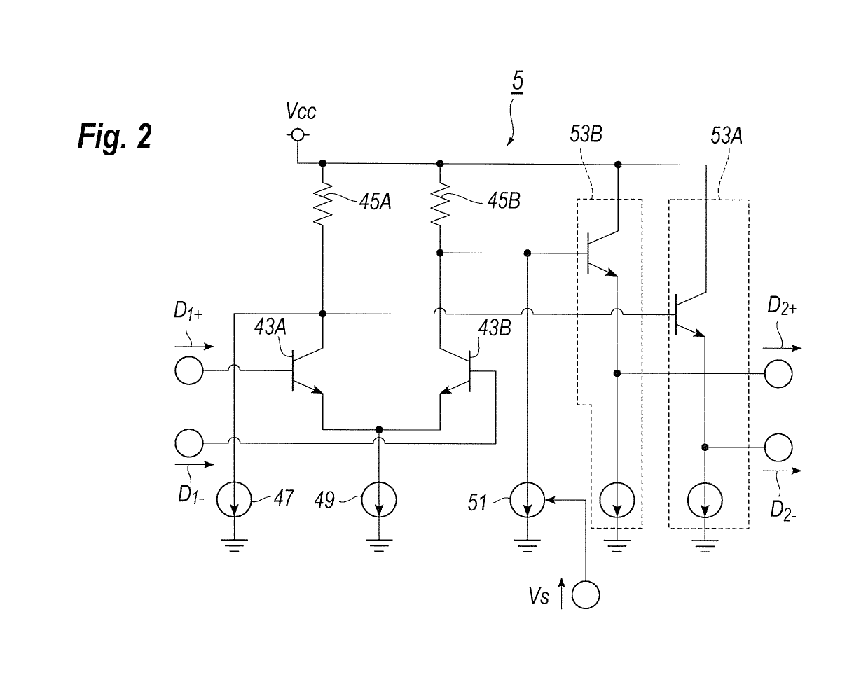

FIG. 1 is a functional block diagram of an LD-driver 1 according to one embodiment of the present invention; meanwhile, FIG. 2 illustrates an arrangement of the offset adjustor shown in FIG. 1. The LD-Driver 1, which may be implemented within an optical transmitter for the optical communication system, drives a semiconductor laser diode (hereafter denoted as LD).

The LD-driver 1 may include the first differential amplifier 3, an offset adjustor 5, a decision unit 7, a selector switch 9, an integrator 11, the second differential amplifier 13, and the third differential amplifier 15. The first differential amplifier receives a pair of input signals, D₀₊ and D₀₋, complementary to each other in two inputs thereof through respective capacitors, 17 and 19. The complementary signals are often called as the positive phase signal and the negative phase signal. A termination resistor 21 is connected between two inputs of the first differential amplifier 3. The first differential amplifier 3 may output a pair of output signals, D₁₊ and D₁₋, which are complementary to each other.

Two inputs of the first differential amplifier 3 are connected to the inputs of the decision unit 7. The decision unit 7 may decide an input status of the LD-driver 1; that is, receiving two signals, D₀₊ and D₀₋, through the capacitors, 17 and 19, and comparing the signal level thereof with a preset level, the decision unit 7 may decide whether substantial input signals are input or not, and output a status signal Loss-of-Signal (LOS).

The offset adjustor 5 may add an offset voltage Vx between respective inputs, D₁₊ and D₁₋, thereof. The offset adjustor 5 according to the present embodiment may vary the offset Vx appeared in the outputs, D₂₊ and D₂₋, of the second amplifier 13. The offset Vx depends on a control signal Vs that reflects an existence or an absence of the input signals, D₀₊ and D₀₋. The selector switch 9 may switch the control signals Vs; that is, when the LOS indicates that no signals are input, the selector switch 9 may select one state V_{NO} as the control signal Vs that means the cross point of 50%, that is, the cross point is in just center between the HIGH and LOW levels. The offset adjustor 5, receiving the control signal Vs corresponding to the cross point of 50%, may minimize the output offset Vx between two signals, D₂₊ and D₂₋, or make the offset Vx substantially zero. On the other hand, when the LOS from the decision unit 7 denotes the existence of the input signals, by which the selector switch 9 may switch the control signal Vs to a state V_{OFF} where the offset adjustor 5 causes a substantial offset Vx between the outputs thereof, D₂₊ and D₂₋. In FIG. 1, the former state of the control signal Vs where the output offset becomes substantially zero is denoted by V_{NO}, while, the latter state where the offset adjustor 7 causes the substantial offset is denoted by V_{OFF}.

The integrator 11, which may be a type of a low-pass filter, is put between the selector switch 9 and the offset adjustor 5. The offset control signal Vs output from the selector switch 9 may gradually increase to the state V_{OFF} to cause the large offset Vx from the state V_{NO}, and may gradually decrease to the state V_{NO} from the other state V_{OFF}.

The second differential amplifier 13, by receiving two signals, D₂₊ and D₂₋, from the offset adjustor 5, may output two signals, D₃₊ and D₃₋, which are also complementary to each other but include the offset Vx depending on the control signal Vs. The last differential amplifier 15, which may function as a driver for driving the LD 31, includes transistors, 23A and 238, resistors, 25A and 25B, and a current source 27 for providing a modulation current to the LD 31. Specifically, the collector of respective transistors, 23A and 23B, are biased by the power supply Vcc through the resistors, 25A and 25B, the emitters thereof are commonly connected to the current source 27, and the bases receive the outputs, D₃₊ and D₃₋, intermittently containing the offset Vx.

The third differential amplifier 15 of the present embodiment in two outputs thereof may be connected to the anode and the cathode of the LD 31 through respective capacitors, 29A and 298. The anode of the LD 31 is biased by the power supply Vcc through an inductor 33; while, the cathode is grounded through a series circuit of an inductor 35 and the current source 37. This current source 38 may provide a bias current to the LD 31 in the DC mode. Two inductors, 33 and 35, connected in series to the LD 31 may electrically isolate the LD 31 from the power supply Vcc and the ground in high frequencies. That is, the power supply Vcc and the ground do not substantially influence the operation of the third differential amplifier 15 in high frequencies.

The LD-driver 1 of the present embodiment may further include inductors, 39 and 41, each connected in parallel to the load resistor, 25A and 25B, of the third differential amplifier 15. When the left transistor 23A turns off, one of the outputs connected in the transistor 23A rapidly increases a voltage level thereof and the other of the inputs connected to the transistor 23B rapidly decreases because of the electro-static induction of the inductors, 39 and 41, from the voltage level of the power supply Vcc. Accordingly, the outputs of the third differential amplifier 15 may swing by the power supply level Vcc as the midpoint thereof. This circuit arrangement makes it possible that, even the power supply is forced set in a relatively small level due to less breakdown voltage of the transistor, especially, in high frequency regions.

Next, the arrangement of the offset adjustor 5 may be described as referring to FIG. 2. The offset adjustor 5 includes two transistors, 43A and 43B, two resistors, 45A and 45B, three current source, 47 to 51, and two emitter followers, 53A and 53B. Two transistors, 43A and 43B, resistors, 45A and 45B, and the current source 49 constitute, as those of the third differential amplifier 15 shown in FIG. 1, a differential amplifier. Specifically, the collector of the transistors, 43A and 43B, are biased by the power supply Vcc through respective load resistors, 45A and 45B, the emitters are commonly connected to the current source 49, and the bases receive the input signals, D₁₊ and D₁₋.

The differential amplifier in the offset adjustor 5 may further includes two current sources, 47 and 51, one of which is connected to the collector of the left transistor 43A may extract a constant current Id from the load resistor 45A determined by the current source 47; while, the other of which, connected to the right transistor 43B, may vary the extracted current in a range from Id−α to Id+α (α>0), namely, Id±α determined by the variable current source 51. The magnitude of the variable extracted current may be determined by the control signal Vs applied to the current source 51. When the decision unit 7 decides the existence of the input signal and the control signal is set in the level of V_{NO}, the variable current source 51 may set the extracted current to be Id to cause no offset between two outputs, D₂₊ and D₂₋, of the offset adjustor 5; meanwhile, when the control signal Vs is in the level corresponding to a state where a substantial offset is caused in the outputs, D₂₊ and D₂₋, or to a state in the transition from the no-offset state to the offset state or from the offset state to the no-offset state, the variable current source 51 may vary the extraction current in the range of Id±α.

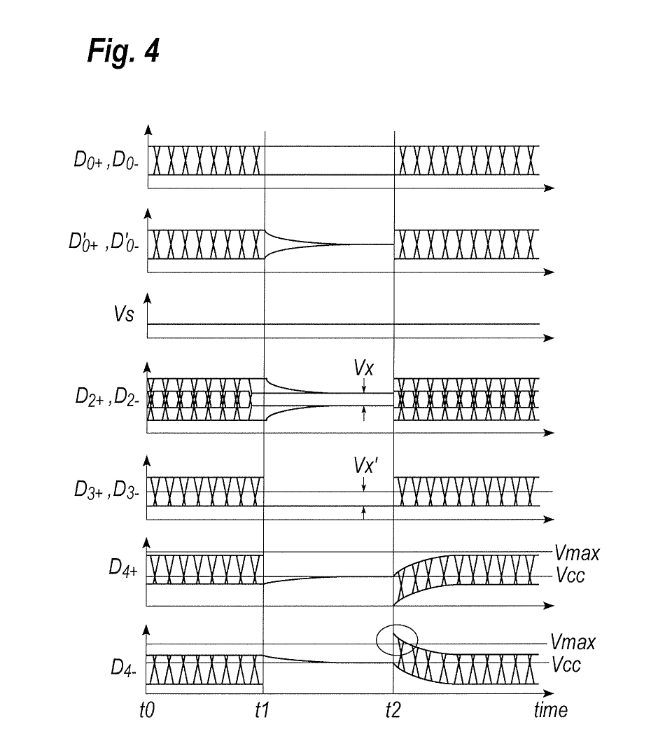

An operation of a comparable driver without the offset controller including the offset adjustor 7, the selector switch 9 and the integrator 11 will be described in advance to the description of the operation of the driver according to the present embodiment. FIG. 4 shows time charts of signals appeared in respective nodes of the comparable LD driver. Input signals, D₀₊ and D₀₋, intermittently shows substantial patterns in a period of t0˜t1 and another period of t2˜; while, fix the level thereof in HIGH or LOW in a period of t1˜t2. In such a pattern, the magnitude of the input signals, D₀₊ and D₀₋, observed at the termination resistor 21 gradually increase or decrease in the period of t1˜t2 by the time constant determined by the termination resistor 21 and the capacitors, 17 and 19, because the termination resistor 21 is coupled in the input terminals in the AC mode through the capacitors, 17 and 19, as shown in the second time chart of FIG. 4. Moreover, the offset control signal Vs in the comparable driver is kept constant in the comparable LD driver because of no offset control function.

Under such a condition above described, the signals, D₂₋ and D₂₊, output from the offset adjustor 5 shifts lower in the positive phase signal thereof while shifts higher in the negative phase signal to cause an offset voltage Vx, as shown in the fourth chart. This offset Vx leaves in the period t1 to t2 during which the input signals are absent. The outputs, D₂₊ and D₂₋, are converted to the signals, D₃₊ and D₃₋ by the second amplifier 13. Because the second amplifier 13 operates as the limiting amplifier, the outputs, D₃₊ and D₃₋, of the second amplifier show the preset and constant amplitude but accompanied with the cross point shift as shown in the fifth chart, which is often called as the cross point distortion or the duty cycle distortion. The outputs, D₃₊ and D₃₋, show the offset Vx′ which reflects the offset Vx of the outputs, D₂₊ and D₂₋, and the gain of the second amplifier 13.

Furthermore, the outputs, D₄₊ and D₄₋, supplied to the LD 31 from the final amplifier 15 is modulated around the power supply Vcc because the final amplifier 13 is pulled in the outputs thereof up to the power supply through respective inductors, 39 and 41. Because the inputs, D₃₊ and D₃₋, of the final amplifier 15 inherently accompany with the cross point distortion, the outputs, D₄₊ and D₄₋, swing such that the respective averages namely the respective cross points become identical with the power supply Vcc, as shown in sixth and seventh charts where the positive phase signal D₄₊ shifts in the higher side from the power supply Vcc while the negative phase signal D₄₋ shifts lower but the respective cross points are substantially equal to the power supply Vcc. Moreover, both outputs, D₄₊ and D₄₋, converge in the power supply Vcc during the LOS period t1˜t2; then, the LD 31 receives substantially no differential signal.

Recovering the input signals at t2, both outputs, D₄₊ and D₄₋, swing from the power supply Vcc by the preset amplitude determined by the limiting function of the second amplifier 13 as above described. Then, one of the outputs, D₄₊ and D₄₋, possibly swings to a level Vcc+amplitude or Vcc-amplitude as showing an overshoot or an undershoot, and gradually converges in the cross point thereof to the power supply Vcc by a time constant determined by the load conditions of the final amplifier 15, namely, the LD 31, the capacitors, 29A and 29B, the inductors, 39 and 41, the output impedance of the final amplifier 15, and so on. The over shoot thus caused in the outputs, D₄₊ and D₄₋, may occasionally exceed the maximum bias condition Vmax allowable for the transistors, 23A and 23B, in the final amplifier 15, as shown in seventh chart of FIG. 4. When the offset control signal Vs sets the offset of the cross point below 50%, the overshoot appears in the negative phase output D₄₋, while, the control signal Vs sets the cross point over 50%, the overshoot appears in the positive output D₄₊.

In an example, when the common emitter level V_{E} of the paired transistors, 23A and 23B, the output swing amplitude, the power supply voltage Vcc, and the cross point shift Vx are 1.0V, 2.0 Vp-p, 3.0V and 0V, respectively; the output of the final amplifier 15 becomes 4.0V in the maximum. However, when an offset Vx′ is added to the output of the second amplifier 13, one of the outputs, D₄₊ or D₄₋, may increase to 5.0V in the maximum. In the former case, namely, when the maximum output is limited to 4.0V, the maximum bias V_{CE} between the collector and the emitter of the output transistor, 23A or 23B, is limited to 3.0V at the maximum, while in the latter case where the output is increased to 5.0V, the bias V_{CE} reaches 4.0V at the maximum. A bipolar transistor applicable to the high frequency use generally has a limited maximum bias condition V_{CE} between the collector and the emitter of about 2.0 to 3.6V; then the comparable driver without cross point adjustment shown in FIG. 4 may cause an excess condition of the V_{CE} when an additional offset is introduce.

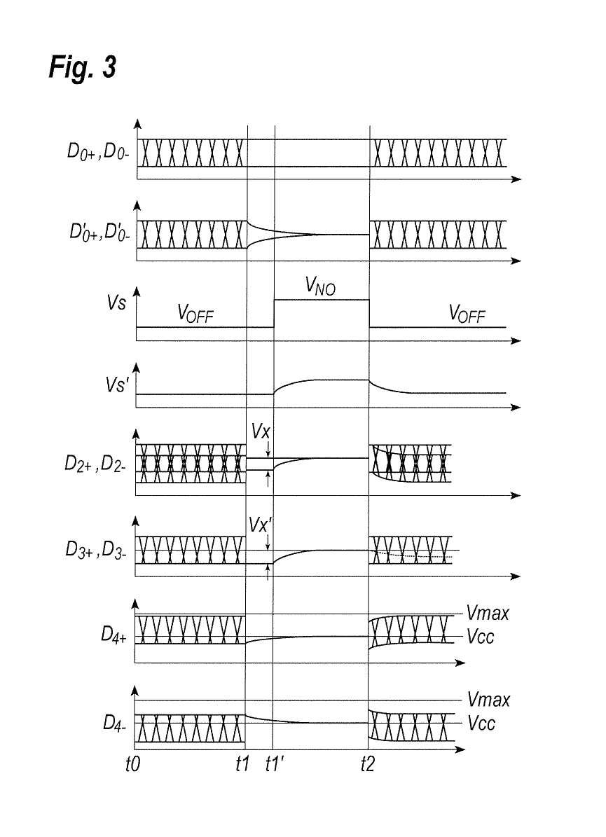

Next, operations of the LD driver 1 according to the present embodiment will be described as referring to FIG. 3 that is time charts of respective nodes in the LD driver 1 of the present embodiment.

The signals, D₀₊ and D₀₋, of the LD driver 1 and the inputs, D₁₊ and D₁₋, after passing the coupling capacitors, 17 and 19, are the same with those shown in FIG. 4 in the comparative LD driver. That is, a practical modulation is carried out in the period t0˜t1 and in another period t2˜; while, substantially no signals input in the period t1 to t2. Because the present LD driver 1 has the decision unit 7 that may determine the existence of the input signals, D₀₊ and D₀₋, or the absence thereof. That is, the decision unit 7 may decide the absence of the input signals, D₀₊ and D₀₋, at t1′ with a lag from the instant t1 when the input signals, D′₀₊ and D′₀₋, in the difference therebetween becomes less than a preset amplitude.

Then, the decision unit 7 sets the LOS and changes the selector switch 9 to switch the offset control signal Vs from V_{OFF} to V_{NO} to cause substantially no offset in the offset controller 5 as shown in the third chart. After recovering the input signals, D₀₊ and D₀₋, the decision unit 7 determines the existence of the signal and negates the LOS to switch the selector switch 9 to change the control signal Vs from V_{NO} to V_{OFF}. Thus, during the period t1′ to t2, the offset controller 5 receives the control signal V_{NO}, which means that the outputs, D₂₊ and D₂₋, of the offset controller 5 include substantially no offset as shown in the fifth chart in FIG. 3. Because the offset control signal Vs is given from the selector switch 9 through the integrator 11 as shown in the symbol Vs′ in the fourth chart in FIG. 3, the offset in the outputs, D₂₊ and D₂₋, of the offset controller 5 gradually approach the no-offset state from the instant t1′.

The outputs, D₂₊ and D₂₋, of the offset controller 5 include the offset Vx therebetween during the inputs, D₀₊ and D₀₋, practically exist till the instant t1 and subsequent lag until the instant t1′ when the inputs, D′₀₊ and D′₀₋, are regarded to exist because of the difference therebetween leaves the substance level. After the lag t1′, the offset control signal Vs′ transits to the level V_{NO} by which the offset disappears in the outputs, D₂₊ and D₂₋. At the instant t2, the inputs, D′₀₊ and D′₀₋, recovers and the offset control signal Vs changes to the state V_{OFF} from the other state V_{NO} to cause a substantial offset in the outputs, D₂₊ and D₂₋, of the offset controller 5. However, the change of the offset control signal Vs is gradually reflected in the signal Vs′ output from the integrator 11; accordingly, the outputs, D₂₊ and D₂₋, of the offset controller 5 may be left in the no-offset state at the instant just after the recovery of the input signals, then gradually shows the substantial offset.

The outputs, D₂₊ and D₂₋, are converted to the signals, D₃₊ and D₃₋, in the limiting mode by the second amplifier 13, where the signals, D₃₊ and D₃₋, show the cross point shift, or the cross point distortion as shown in the sixth chart in FIG. 3. The signals, D₃₊ and D₃₋, whose high and low levels are fixed to respective voltages by the limiting function of the second amplifier 13 but leaves the substantial offset Vx′ till the instant t1′ after the absence of the input signals, D₀₊ and D₀₋. The outputs, D₃₊ and D₃₋, of the second amplifier 13 gradually converges to the present value by the time constant of the integrator 11 to disappear the offset Vx′ because the offset control signal Vs′ is set to the value V_{NO} to cause substantially no offset in the outputs, D₃₊ and D₃₋, at the instant t1′.

At the instant t2 when the input signals, D₀₊ and D₀₋, recover, the outputs, D₃₊ and D₃₋, are left in the no-offset state; accordingly, the signals in the downstream of the second amplifier 13 may be recovered from the no-offset state. Then, the cross point of the outputs, D₃₊ and D₃₋, of the second amplifier 13 causes the substantial shift responding to the offset control signal Vs′ output from the integrator 11, which gradually converges to the level V_{OFF} to cause the substantial offset in the cross point of the outputs, D₃₊ and D₃₋, which may be reflected in the driving signals, D₄₊ and D₄₋, output from the last amplifier 15.

The outputs, D₄₊ and D₄₋, of the third amplifier 15 shows the offset cross point when the input signals, D₀₊ and D₀₋, exist in the input of the first amplifier 3, which is shown in the seventh and the eighth charts of FIG. 3. That is, the positive phase output D₄₊ shows the lowered cross point, while, the negating phase output D₄₋ shows the increased raised cross point until the instant t1. When the input signals, D₀₊ and D₀₋, become absent, The outputs, D₄₊ and D₄₋, gradually converges to the power supply level Vcc just after the instant t1 without any lag because the third amplifier 15 is pulled in the outputs thereof up to the power supply Vcc through the inductors, 39 and 41. Moreover, in the present embodiment of the invention, the inputs of the third amplifier 15, which are the outputs, D₃₊ and D₃₋, of the second amplifier cause no offset; accordingly, the outputs, D₄₊ and D₄₋, of the third amplifier may recover from the no offset state at the instant t2, then gradually shift the offset thereof responding to the gradual change of the offset control signal Vx′. Thus, even when the inputs, D₀₊ and D₀₋, intermittently recover from the absent state at the instant t2, the outputs, D₄₊ and D₄₋, do not cause large overshoot or undershoot, which may bring an enough tolerance of the bias conditions in the output transistors, 23A and 23B.

In the foregoing detailed description, the LD Driver circuit of the present invention have been described with reference to specific exemplary embodiments thereof. It will be evident that various modifications and changes may be made thereto without departing from the broader spirit and scope of the present invention. For instance, the embodiment shown in FIGS. 1 and 3 has the decision unit 7 without any time lag to reverse the output LOS thereof; that is, the decision unit 7 occasionally regards a noise as the existence or the recovery of the input signals to release the LOS, which causes the substantial offset in the outputs, D₂₊ and D₂₋, or D₃₊ and D₃₋. Accordingly, a decision unit 7 may implement with the function to re-check the existence of the input signal with a time lag after the unit 7 once decides the existence. Even in a case where such a decision unit is implemented, the function of the offset adjustor 5 of the present embodiment may show the function, the way, and the result same as those above described.

Moreover, although the LD driver of the embodiment has the differential configuration from the inputs to the outputs thereof; the function, the way and the result may be reflected in a driver circuit with the signal phase arrangement. That is, the offset controller adjust the offset between two output signals depending on the existence/absence of the input signal, the offset controller may adjust a bias level of the output thereof and those in the downstream amplifier. When the input is absent, the offset controller may set the output thereof to be in a raised bias with respect to the power supply, while, the offset controller may lower the bias in the output thereof. Accordingly, the overshoot caused in the output of the driver may decrease the magnitude thereof because the output of the controller, at the instant of the recovery of the input signal, is raised and has a restricted room to the power supply Vcc. Thus, the present specification and figures are accordingly to be regarded as illustrative rather than restrictive.

What is claimed is:

1. A driver circuit for a semiconductor laser diode, comprising:
a decision unit for generating a control signal whose level corresponds to an existence and an absence of an input signal provided to the driver circuit;
an offset adjustor for receiving the input signal and adding an offset to an output of the offset adjustor by receiving the control signal from the decision unit; and
an amplifier for receiving the output of the offset adjustor and driving the semiconductor laser diode, the amplifier having an output terminal pulled up to a power supply through an inductor,
wherein the offset adjustor adds an offset to the output thereof when the input signal exists and compensates the offset when the input signal is absent.

2. The driver circuit of claim 1,
further including a selector switch and an integrator,
wherein the selector switch selects one of control signals each corresponding to the existence of the input signal and the absence of the input signal, the integrator integrating an output of the selector switch,
wherein the offset adjustor receives an output of the integrator as the control signal to adjust the offset of the output thereof.

3. The driver circuit of claim 1,
wherein the decision unit, the offset adjustor, and the amplifier have a differential arrangement to handle a positive phase signal and a negative phase signal complementary to each other; and
wherein the decision unit decide the existence or the absence of the input signals by a difference between two input signals, and
wherein the offset adjustor raises or lowers one of outputs thereof by receiving the control signal from the decision unit.

4. The driver circuit of claim 3,
wherein the amplifier includes a differential amplifier having a pair of bipolar transistors, and a pair of load resistors, the bipolar transistors each receiving respective outputs of the offset adjustor in a base thereof and being connected to respective load resistors to form respective output terminals, the load resistors each connected between respective output terminal and the power supply,
wherein the laser diode is connected between two output terminals of the amplifier.

5. The driver circuit of claim 4,
wherein the laser diode is biased from the power supply through an inductor and grounded through another inductor,
wherein the laser diode receives an outputs of the amplifier in an AC mode through coupling capacitors.

6. The driver circuit of claim 4,
wherein the output terminals of the amplifier swing in a voltage level thereof around the power supply when the input signals exist.

7. The driver circuit of claim 3,
wherein the offset adjust includes a differential amplifier having a pair of bipolar transistors, a pair of load resistors, two current sources,
wherein one of current source is a type of a constant current source to extract an extra current from a current flowing in one of load resistors, another current source is a type of a variable current source to extract another extra current from a current flowing in other of load resistors,
wherein the other extra current is varied around the extra current by the control signal provided from the decision unit.
